(19) United States
(12) Patent Application Publication
(10) Pub. No.: US 2014/0211810 A1
(43) Pub. Date: Jul. 31, 2014

(54) Methods and Devices for Establishing a Communication

(71) Applicant: SIEMENS AKTIENGESELLSCHAFT, München (DE)

(72) Inventors: Andreas Heinrich, Boblingen (DE); Jörg Heuer, Oberhaching (DE); Sebastian Käbisch, Munchen (DE)

(21) Appl. No.: 14/238,413

(22) PCT Filed: Jul. 24, 2012
(86) PCT No.: PCT/EP12/64479

§ 371 Date: Feb. 11, 2014

(30) Foreign Application Priority Data
Aug. 11, 2011 (EP) 11177216

(51) Int. Cl. H04L 29/06

(52) U.S. Cl. CPC H04L 69/08; H04L 69/22
USPC 370/466

(57) ABSTRACT

The invention relates to methods and devices for establishing a communication. A first communication message comprises a first header field and an application data field. The first header field of a first communication message is converted, on the basis of a scheme, into a second header field that can have an XML-based structure. Furthermore, the second header field is transferred into a third header field using a compression method, a second communication message being formed by this third header field and the application data field. The invention can be used, for example, for machine-to-machine communication.

The invention relates to methods and devices for establishing a communication.

In recent years machine-to-machine communication, i.e. an exchange of messages between two central processing units, for example via the internet, has increased considerably. An application of this machine-to-machine communication involves, for example, wireless sensor networks with a large number of self-sufficient sensors. Such self-sufficient sensors have a small central processing unit with a very limited memory, e.g. 50 kbytes, a battery for power supply and a wireless interface for data transmission. The self-sufficient sensors provide information such as, for example, temperature or air pressure, this information being sent directly or conveyed via several self-sufficient sensors to a receiving station for evaluation. In professional circles such self-sufficient sensors are known, inter alia, as MOTS. A property of these self-sufficient sensors is that they only have a very limited energy capacity, for example obtained by sunlight. Due to this, their processing power and therefore their power consumption is greatly reduced. Another field of application for self-sufficient central processing units with very reduced hardware is an embedded system in which, inter alia, several self-sufficient central processing units jointly perform a service such as, for example, a web service.

In many conventional wired systems machine-to-machine communication is today handled via IP (IP—35 Internet Protocol), TCP (TCP—Transport Control Protocol), UDP (UDP—Uniform Datagram Protocol) and/or HTTP (HTTP—Hypertext Protocol) protocols. These protocols are used in a variety of devices with a wide range of hardware and operating systems, it being preferable for self-sufficient sensors to also exchange data via such protocols.

However, these protocols were designed without regard for a bandwidth efficient display. Therefore, compression algorithms were and are developed which significantly reduce the volume of information, i.e. messages, to be transmitted, resulting in the bandwidth and transmitting power required to transmit these messages also being reduced. An example of this is Chopan, a compression method proposed by IETF (IETF—Internet Engineering Task Force), see [1], which aims to reduce the bandwidth volume required to transmit HTTP messages. In addition, there are also algorithms, such as for example EXI (EXI—Efficient XML Interchange), see [2], W3C (W3C—WWW Consortium), which compresses XML data in an efficient manner.

However, in practice it appears that the use of the aforementioned protocols with and without corresponding compression algorithms for self-sufficient central processing units and self-sufficient sensors may nevertheless be highly complicated and therefore be an obstacle to using the protocols known from wired machine-to-machine communication.

The object of the present invention is therefore to specify a method and a device which enable the use of communication messages using the HTTP protocol (=Hyper Text Transfer Protocol) for communication devices, such as MOTS, with little processing power and low power consumption.

This invention is achieved by the independent claims. Developments of the invention can be found in the dependent claims.

The invention relates to a method for establishing a communication between two networks using the following steps:
Receipt of a first message from the first network, the first message comprising a first header field and a first application data field and the first header field comprising data in accordance with the Hyper Text Transfer Protocol standard;
Coding of at least one of the fields of the first header field as an element and/or attribute respectively on the basis of an XML scheme into a second header field;
Coding of the second header field into a third header field on the basis of a compression method, the compression method reducing a data volume of the second header field;
Creation of a second message comprising the third header field and the first application data field;
Transmission of the second message to the second network.

The present method is characterized in that the first header field coded as HTTP (HTTP—Hypertext Transfer Protocol) is first transferred to an XML-based display (XML—Markup Language) [3, 4, 5] which for its part can be coded using a standard XML binary compressor. In this connection, it is advantageous that the HTTP syntax can be transferred to an XML-based syntax which for its part is binary compressed by a standardized compression method. For the invention is based on the knowledge that for machine-to-machine communication an XML-based application data field containing information is often transferred, which for its part can also be compressed by means of the XML binary compressor, with a synergetic effect arising through the use of an identical compression method for the third header field and the compressed application data field of the second message.

Consequently, a first compression algorithm for the HTTP-coded first header field and a second compression algorithm for the data field need not be installed and executed on the terminal, as is customary today. Rather, the invention is characterized in that on the one hand, a standardized description language, i.e. XML, can be used by converting the first header field into the XML-based header field. Therefore it is advantageous that in a terminal with minimum processing power, memory size and a very limited energy supply only one compression algorithm need be implemented which is, however, in a position to also code the HTTP part of the communication message on account of the conversion of the first header field to the XML-coded header field.

The term HTTP relates to the Hypertext Transfer Protocol HTTP standard, as defined in RFC 1945 for HTTP/1.0 [3] and in RFC 2616 for HTTP/1.1 [4]. Furthermore, the description language Extensible Markup Language XML is specified by the World Wide Web Consortium W3C, see for example [5]. With regard to HTTP and XML, the invention not only relates to the aforementioned standard texts, but also to future developments of these standard texts.

The scheme defines the syntax, the element names and attributes as well as ranges of values for attributes of the second header field to be created. In the process, the creation of the scheme may take place specifically for the second header field or based on the HTTP standard, for a number of fields or parameters of the HTTP standard or also for all the possible fields or parameters of the HTTP standard. The created scheme may either be created centrally in order to be subsequently forwarded to the terminals concerned or alternatively, the scheme, in particular the scheme for the fields of the HTTP standard, may be generated in its own right or already be stored during an initialization of the respective terminal, e.g. in the ROM (ROM—Read Only Memory), on any terminal which is to receive or provide the second message. The creation of the scheme enables the XML-based header field to be created without additional overheads for the signaling of possible scheme versions.

Particularly for machine-to-machine communication the application data field comprises XML-based data, for example for the signaling of web services in accordance with the SOAP standard (SOAP—Service Oriented Application Protocol). In this connection it is advantageous that both the HTTP-based first header field as well as the application data field are compressed in an identical manner so that only one compressor or decompressor needs to be used for the terminal which analyzes and compresses the first application data field and the second header field.

During the compression of the application data field into the coded application data field, fields of the http-based first header field can also be adapted. A first field represents a number of bytes of the data field. The value of this first field is adapted to the number of bytes of the coded data field. Furthermore, a second field of the http-based first header field which describes the type of data field is adapted to the type of compressor used for compression. This ensures that the terminal which receives the second message can process the third header field and the compressed application data field without errors.

Furthermore, a terminal which receives the second message may be in a position to process the third header field in its binary representation, i.e. omit decompression and conversion of the XML-based header field into the HTTP-based first header field. This option exists, for example, when using the EXI coder standardized by W3C, i.e. compressor. This has the advantage that the terminal can process the second message in its compressed form and thus on the one hand processing power for decompression and transfer to the format in accordance with the first message can be avoided while on the other hand, a saving of storage capacity is achieved as the third header field has a considerably reduced storage volume compared with the first header field.

On the whole, this has the advantage that by using the display of the header field with XML a very flexible display is achieved compared with other protocols, such as Chopan, see W. Furthermore, the use of XML and the XML binary compressor enables easy integration into existing systems, for example in the context of building services.

In an broadening, the first application data division is coded in accordance with the compression method. An additional reduction in the data of the second message can be achieved by this means. In particular, in the case of terminals with limited memory, storage of the second message in an efficient manner can be achieved by this means.

The invention also relates to a method for establishing a communication between two networks, with the following steps:
Receipt of a second message from a second network, the second message comprising a third header field and a first application data field and at least the third header field being coded in accordance with a compression method;
Decoding of the third header field into a second header field on the basis of a decompression method corresponding to the compression method;
Coding of elements and/or attributes of the second header field on the basis of an XML scheme into respective fields, the fields having a syntax in accordance with the Hyper Text
Transfer Protocol standard and the fields forming a first header field;
Creation of a first message with the first header field and the first application data field;
Sending of the first message to the first network.

This method relates to the decoding of the second message into the first message. The advantages are analogous to the aforementioned method for establishment.

The method may be supplemented by the first application data division being decoded in accordance with a decompression method corresponding to the compression method. This enables very compact coding of the second message, i.e. with few bits.

Both methods are preferably broadened by the use of an Efficient XML Interchange (EXI) standard or a Binary MPEG format for XML (BIM) as a compression method. By this means, realization can be simplified as recourse may be had to standardized modules which realize the respective standard. The Efficient XML Interchange (EXI) standard is known from document [2] and the Binary MPEG format for XML (BIM) standard from document [6].

In addition, the invention comprises a coding device for establishing a communication between two networks, with the following units:
First unit for receiving a first message from the first network, the first message comprising a first header field and a first application data field and the first header field comprising data in accordance with the HyperText Transfer Protocol standard;
Second unit for coding of at least one of the fields of the first header field as an element and/or attribute respectively on the basis of an XML scheme into a second header field;
Third unit for coding of the second header field into a third header field on the basis of a compression method, the compression method reducing a data volume of the second header field;
Fourth unit for creating a second message comprising the third header field and the first application data field;
Fifth unit for sending the second message to the second network.

In an broadening of the coding device, furthermore this comprises a sixth unit which is designed in such a way that broadenings of the method can be executed therewith.

Finally, a decoding device for establishing a communication between two networks is part of the invention, with the following units:
Seventh unit for receiving a second message from a second network, the second message comprising a third header field and a first application data field and at least the third header field being coded in accordance with a compression method;
Eighth unit for decoding the third header field into a second header field on the basis of a decompression method corresponding to the compression method;
Ninth unit for coding of elements and/or attributes of the second header field on the basis of an XML scheme into respective fields, the fields having a syntax in accordance with the HyperText Transfer Protocol standard and the fields forming a first header field;
Tenth unit for establishing a first message having the first header field and the first application data field;
Eleventh unit for sending the first message to the first network.

Furthermore, the decoding device may comprise a twelfth unit which is designed in such a way that broadenings of the method can be executed therewith.

The coding and decoding devices have the same advantages as the corresponding methods.

The invention and its developments are illustrated in more detail with reference to figures. These are:

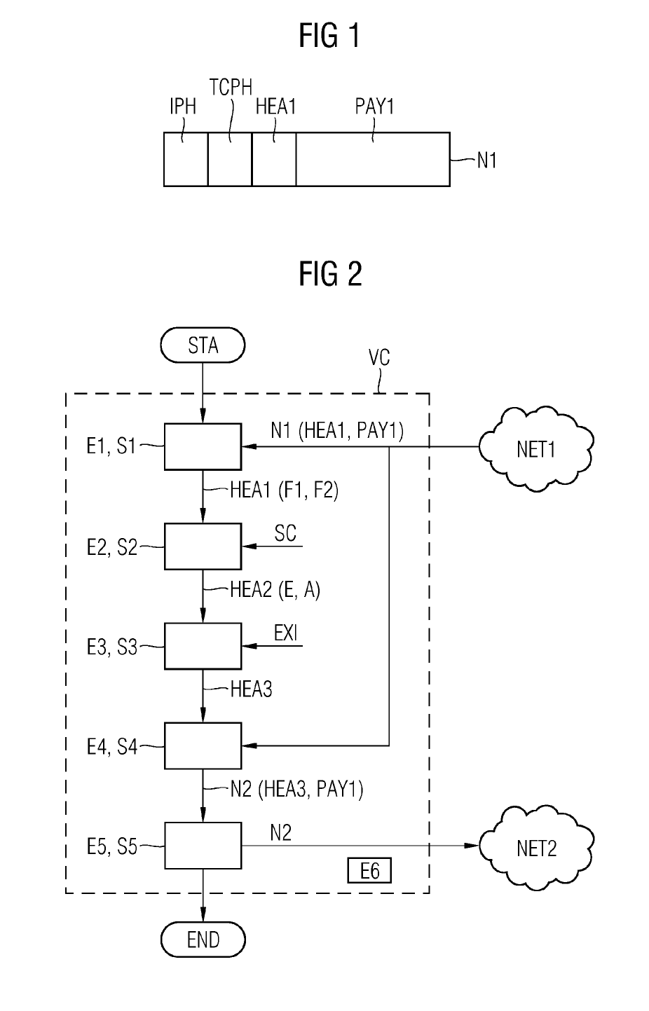

FIG. 1 schematic structure of a communication message according to the prior art

FIG. 2 a transmit-side flow chart of the method according to the invention

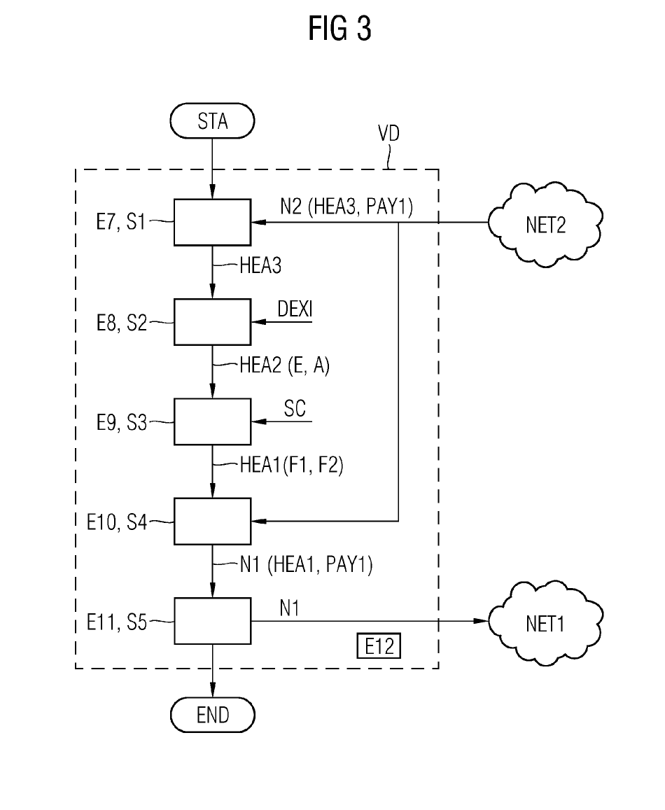

FIG. 3 a receiver-side flow chart of the method according to the invention

Elements with the same function and mode of action are provided with the same reference characters in the figures.

FIG. 1 shows an example of a communication message, hereinafter referred to as the first message N1, with an IP header field IPH, a TCP header field TCPH, a first header field HEA1, which comprises data in accordance with the HTTP (Hyper Text Transfer Protocol) standard, and a first application data field PAY1 in accordance with the OSI layer model (OSI—Open Standard Interface).

Today such a message is usually used for machine-to-machine communication as well as for man-to-machine communication, e.g. to retrieve contents in the World Wide Web. The terms IP (Internet Protocol), TCP (Transport Control Protocol) and HTTP are sufficiently well known to a person skilled in the field of communications technology, obviating the need for any further explanation at this point. The first application data field PAY1 may have structured data in accordance with the XML standard (XML—Extensible Markup Language), which for example, represents a SOAP message (SOAP—Service Oriented Architecture Protocol).

FIG. 2 shows an exemplary flow chart for execution of the method. This flow chart is started in the status STA.

In a first step S1 the first message N1 is received from a first network NET1. The first network NET1 is, for example, a public internet or a data bus within a computer system which provides the first message N1 for further processing. The first step S1 may be implemented and executed with a first unit E1.

In a second step S2, the data of the first header field is analyzed on the basis of a scheme SC and the respective fields F1, F2 of the data are reproduced in a structured display as XML elements E and/or attributes A. The scheme SC describes the syntax of one or more fields or parameters of the HTTP standard. An approach for establishing schemes is sufficiently well known to a person skilled in the field of structured documents, obviating the need for a more detailed description of this step at this point. A second header field HEA2 is created by coding the fields F1, F2 in a structured display. The second step S2 may be implemented and executed with a second unit E2.

In a third step S3, a data volume of the second header field HEA2 is reduced by a compression method EXI. In this connection, in particular, an “Efficient XML Interchange” standard or a Binary MPEG format for XML (MPEG Motion Picture Expert Group), is particularly suitable as a compression method. The third header field HEA3 is generated by this coding step. The third step S3 may be implemented and executed with a third unit E3.

In a fourth step S4 a second message N2 is formed by the third header field HEA3 and the first application data field PAY1. The fourth step S4 may be implemented and executed with a fourth unit E4.

This second message N2 is transferred to a second network NET2 in a fifth step S5. The second network NET2 is, for example, a network with MOTS (=self-sufficient wireless sensor units) or an additional data bus in a computer system which takes over the second message N2 for additional processing. The fifth step S5 may be implemented and executed with a fifth unit E5.

The flow chart ends in the status END.

The method in accordance with the aforementioned explanation may be broadened such that in the fourth step the first application data field PAY1 of the second message N2 is coded by means of the compression method EXI. This broadening may be realized with a sixth unit E6.

A coding device VC comprises the units E1 to E6 in the aforementioned embodiment.

FIG. 3 shows an additional exemplary flow chart of the method.

The flow chart is started in a step STA.

In a first step S1 the second message N2 is received from the second network NET2. The second message comprises the third header field HEA3 and the first application data field PAY1. The first step S1 can be implemented and executed with a seventh unit E7.

In a second step S2 the third header field HEA3 is decoded in the second header field HEA2 on the basis of a decompression method DEXI corresponding to the compression method EXI. In this connection, in particular, an “Efficient XML Inter-change” standard or a Binary MPEG format (BIM) for XML (MPEG Motion Picture Expert Group) is particularly suitable as a decompression method. The second step S2 may be implemented and executed with an eighth unit E8.

In a third step S3, elements E and/or attributes A of the second header field are coded in fields F1, F2 of the first header field HEA1 on the basis of the scheme SC. In the process, coding of the fields F1, F2 follows a syntax in accordance with the Hypertext Transfer Protocol standard. The third step S3 may be implemented and executed with a ninth unit E9.

In a fourth step S4, inter alia, the first message N1 is created by arranging the first header field HEA1 and the first application data field PAY1 consecutively. The fourth step S4 may be implemented and executed with a tenth unit E10.

In a fifth step S5 the first message N1 is forwarded to the first network. The fifth step S5 may be implemented and executed with an eleventh unit E11.

The flow chart ends in the status END.

The method in accordance with FIG. 3 may be broadened in such a way that in the fourth step the first application data field PAY1 of the second message N2 is decoded by means of the decompression method EXI, if the first application data field was coded accordingly by the coding device. This broadening can be realized with a twelfth unit E12.

A decoding device VD comprises the units E7 to E12 in the aforementioned embodiment.

The units E1 to E12 can be realized and executed as software, hardware or in a combination of software and hardware. At least some of the units E1 to E12 can be realized on a microcontroller with coupled memory and an associated communication interface, for example in accordance with the WLAN (WLAN—Wireless Local Area Network) standard as per IEEE 802.11 (IEEE—Institute for Electrical and Electronics Engineers).

### REFERENCES

[1] Chopan http://tools.ietf.org/pdf/draft-frank-61owpan-chopan-00.pdf

[2] W3C, EXI “Efficient XML Interchange”, http://www.w3.org/tr/200 9/cr-exi-20091208/

[3]IETF, Hypertext Transfer Protocol, Version HTTP/1.0, see RFC 1945, http://tools.ietf.org/html/rfc1945

[4] IETF, Hypertext Transfer Protocol, Version HTTP/1.1, see RFC 2616, http://tools.ietf.org/html/rfc2616

[5] W3C, Extensible Markup Language (XML) 1.0 (Fifth Edition), see http://www.w3.org/TR/2008/REC-xml-20081126/

[6] Information Technology—MPEG Systems Technologies—Part 1: Binary MPEG format for XML, ISO/IEC FDIS 23001-1:2005 (E), ISO/IEC JTC 1/SC 29/WG11, w7597, Nov. 4, 2005

1. A method for establishing a communication between two networks (NET1, NET2), with the following steps:
Receipt of a first message (N1) from the first network (NET1), the first message (N1) comprising a first header field (HEA1) and a first application data field (PAY1) and the first header field (HEA1) comprising data (DATA) in accordance with the Hyper Text Transfer Protocol standard;
Coding of at least one of the fields (F1, F2) of the first header field (HEA1) as an element (E) and/or attribute (A) respectively on the basis of an XML scheme (SC) into a second header field (HEA2);
Coding of the second header field (HEA2) into a third header field (HEA3) on the basis of a compression method (EXI), the compression method (EXI) reducing a data volume of the second header field (HEA2);
Creation of a second message (N2) comprising the third header field (HEA3) and the first application data field (PAY1);
Sending of the second message (N2) to the second network (NET2).

2. The method as claimed in claim 1,
characterized in that
the first application data division (PAY1) is coded in accordance with the compression method (EXI).

3. A method for establishing a communication between two networks (NET1, NET2), with the following steps:
Receipt of a second message (N2) from a second network (NET2), the second message (N2) comprising a third header field (HEA3) and a first application data field (PAY1) and at least the third header field (HEA3) being coded in accordance with a compression method (EXI);
Decoding of the third header field (HEA3) into a second header field (HEA) on the basis of a decompression method (DEXI) corresponding to the compression method (EXI);
Coding of elements(E) and/or attributes(A) of the second header field (HEA2) on the basis of an XML scheme (SC) into respective fields (F1, F2), the fields (F1, F2) having a syntax in accordance with the Hyper Text Transfer Protocol standard and the fields (F1, F2) forming a first header field (HEA1); Creation of a first message (N1) comprising the first header field (HEA1) and the first application data field (PAY1);
Sending of the first message (N1) to the first network (NET1).

4. The method as claimed in claim 3,
characterized in that
the first application data division (PAY1) is decoded in accordance with a decompression method (DEXI) corresponding to the compression method (EXI).

5. The method as claimed in one of the preceding claims, characterized in that an Efficient XML Interchange standard or a Binary MPEG format for XML is used as a compression method (EXI).

6. A coding device (VC) for establishing a communication between two networks (NET1, NET2), with the following units:
First unit (E1) for receiving a first message (N1) from the first network (NET1), the first message (N1) comprising a first header field (HEA1) and a first application data field (PAY1) and the first header field (HEA1) comprising data (DATA) in accordance with the HyperText Transfer Protocol standard;
Second unit (E2) for coding of at least one of the fields (F1, F2) of the first header field (HEA1) as an element (E) and/or attribute (A) respectively on the basis of an XML scheme (SC) into a second header field (HEA2);
Third unit (E3) for coding the second header field (HEA2) into a third header field (HEA3) on the basis of a compression method (EXI), the compression method (EXI) reducing a data volume of the second header field (HEA2);
Fourth unit (E4) for creating a second message (N2) comprising the third header field (HEA3) and the first application data field (PAY1);
Fifth unit (E5) for sending the second message (N2) to the second network (NET2).

7. The coding device (VC) as claimed in claim 6,
which in addition comprises a sixth unit (E6) which is designed such that broadenings of the method as claimed in claim 2 or 5 can be executed.

8. A decoding device (VD) for establishing a communication between two networks (NET1, NET2), with the following units:
Seventh unit (E7) for receiving a second message (N2) from a second network (NET2), the second message (N2) comprising a third header field (HEA3) and a first application data field (PAY1) and at least the third header field (HEA3) being coded in accordance with a compression method (EXI);
Eighth unit (E8) for decoding the third header field (HEA3) in a second header field (HEA) on the basis of a decompression method (DEXI) corresponding to the compression method (EXI);
Ninth unit (E9) for coding of elements (E) and/or attributes (A) of the second header field (HEA2) on the basis of an XML scheme (SC) into respective fields (F1, F2), the fields (F1, F2) having a syntax in accordance with the HyperText Transfer Protocol standard and the fields (F1, F2) forming a first header field (HEA1);
Tenth unit (E10) for establishing a first message (N1) comprising the first header field (HEA1) and the first application data field (PAY1);
Eleventh unit (E11) for sending the first message (N1) to the first network (NET1).

9. The decoding device (VD) as claimed in claim 8, which in addition comprises a twelfth unit (E12) which is designed such that broadenings of the method as claimed in claim 4 or 5 can be executed therewith.
